(19) United States
(12) Patent Application Publication
(10) Pub. No.: US 2010/0255450 A1
(43) Pub. Date: Oct. 7, 2010

(54) SYSTEM OF ASSOCIATIVE LEARNING

(75) Inventors: James Mauch, St. Petersburg, FL (US); Michelle Mauch, St. Petersburg, FL (US)

Correspondence Address: CHRISTOPHER PARADIES, PH.D., FOWLER WHITE BOGGS P.A., 501 E KENNEDY BLVD, STE. 1700, TAMPA, FL, 33602, US

(73) Assignee: Logiology, LLC, St. Petersburg, FL (US)

(21) Appl. No.: 12/816,039

(22) Filed: Jun. 15, 2010

Related U.S. Application Data
(63) Continuation of application No. 11/278,801, filed on Apr. 5, 2006, now abandoned.

(51) Int. Cl. G09B 19/00

(52) U.S. Cl. 434/236

(57) ABSTRACT

A system of learning includes a flexible associative learning method where images are associated with words, physical objects, color, size, sounds of syllables, acronyms, text or any combination thereof. The images are related to functional aspects of a concept. The method of the system may adjust the color, font size, shape or any other feature of a familiar object, words associated with concepts or both to reinforce associations, such as in imagery-based narratives. Furthermore, interactive systems and physical objects may be used to reinforce associations between imagery and the functional aspect of a concept.

### RELATED APPLICATION

This application is a continuation of U.S. Non-Provisional application Ser. No. 11/278,801 filed Apr. 5, 2006, which is all incorporated by reference herein in its entirety.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The field relates to learning and memory systems and methods of learning.

### BACKGROUND

Learning and memory systems are widely known but have been fraught by problems.

Professor Myers, in his book, Psychology, pgs. 343-383, 2004, in the chapter entitled, Memory, mentions that it is known to remember words that lend themselves to picture images better than remembering abstract, low imagery words. Furthermore, Margaret Matlin, in her text, Cognition, pgs. 170-179, 1998, states that research consistently shows that imagery is most effective when the items that must be recalled are shown interacting with each other. For example, she states that if one wants to remember the pair, “elephant” and “dollar bill,” one should visualize an elephant holding a dollar bill in its trunk. This is used for memorizing shopping lists and other lists of words.

Although David Myers in his textbook, Psychology, notes that people remember words that lend themselves to picture images better than remembering abstract, low imagery words, the picture images for complex concepts are not always helpful. Books written by Harry Lorayne, including Super Memory, Super Student: How to Raise Your Grades in 30 Days, pg. 15, 1990, emphasize that in order for a person to remember a new thing, the new thing must be associated with something one already knows or remembers. However, this is only effective to memorize lists of words or names. For example, on pg. 148, Lorayne, states that one way to remember the acronym for the molecule, adenosine diphosphate (ADP), would be an ape and a dean eating a pea. While this might allow a student to remember the initials ADP, it is ineffective for learning concepts such as what ADP is and how it is used in biology.

Margaret Matlin in her text, Cognition, pg. 172, 1998, notes that word association does produce superior short term recall immediately after learning, but without repeated testing, pictures of the keyword and repeated rehearsal, keyword-based associative memories are fragile. Also, merely associating keywords with images fails to teach abstract concepts, processes and ideas.

### SUMMARY OF THE INVENTION

A system of learning comprises a flexible associative method relating images of familiar objects associated with text, text and physical objects, or physical objects, color, size, sounds of syllables, acronyms, words or combinations thereof to memorize and learn abstract concepts that previous associative learning methods fail to address. In one example, the information relates to a concept. Concepts may be associated with text, objects, images of physical objects, colors, sizes, sounds of acronyms, syllables, words or combinations thereof. Images may be animated using a computer program or a display device connected to a video player, such as a DVD or a CD player.

One advantage of the system is capable of associating functional aspects of abstract concepts. Logic association may associate a characteristic feature with conceptual information. Logical reasoning may show a commonality between the object and the conceptual information. Font size, shape or color may assist with making an association between images and functional aspects of concepts, improving memory retention.

Another advantage is that functional aspects of concepts may be taught in such a way that the concepts build one upon the other, reinforcing memory retention. Also, many aspects of text and images may be used to associate the text and images to functional aspects of concepts. For example, a concept denoting a smallest division of a living being, i.e., the cell may be written as “the smallest thing” with a comparatively small font size associating the font size with the concept of the cell as the smallest division, as one aspect to reinforce this association.

Yet another advantage is that the system of learning may be used to explain functional aspects of concepts such as biological processes, using imagery-based narratives.

Yet another advantage is that interactive systems may utilize such a system of learning. Electronic visualization systems include, without limitation, computer-related devices, televisions, video games and combinations thereof. In another example, an interactive system may incorporate three-dimensional physical objects such as puzzles, toys, other tangible objects and other objects may be associated with functional aspects of concepts.

Some embodiments of this invention address shortcomings of other learning techniques. A system using enhanced text, puzzles and video games, may be used to provide images to be associated with keywords, such that the keywords are memorized in context with functional aspects of concepts associated with the keywords. By constructing a puzzle or playing a video game, a system allows for repeated rehearsal and testing of the associated learning, providing yet another advantage over the fragile associations provided by other methods.

One advantage is that a system of learning is capable of associating images with concepts such that a logical association is established between the images, keywords associated with the concepts, and functional aspects of the concepts.

### BRIEF DESCRIPTION OF THE FIGURES

The drawings illustrate examples of the present invention, but the invention should not be limited merely to the examples disclosed.

FIGS. 1A and B depict examples of a system of associative learning.

FIG. 2 shows another example.

FIGS. 3A and B illustrate another example.

FIG. 4 shows another example.

FIG. 5 depicts yet another example.

FIG. 6 illustrates an example of an interactive system of associative learning.

FIG. 7 shows an example of a three-dimensional object used in one example of associative learning.

FIGS. 8 and 9 depict examples of an imagery-based narrative according to one example of associative learning.

FIGS. 10-18 illustrate additional examples of associative learning using an imagery-based narrative.

### DETAILED DESCRIPTION OF PREFERRED EMBODIMENTS OF THE INVENTION

This detailed description and the drawings provide some examples of the present invention, which should not be limited merely to the examples disclosed. Instead, the invention should be limited only by the claims that eventually issue. Many variations in the examples and uses of systems for associative learning will be readily apparent to those familiar with the field based on the drawings and descriptions provided.

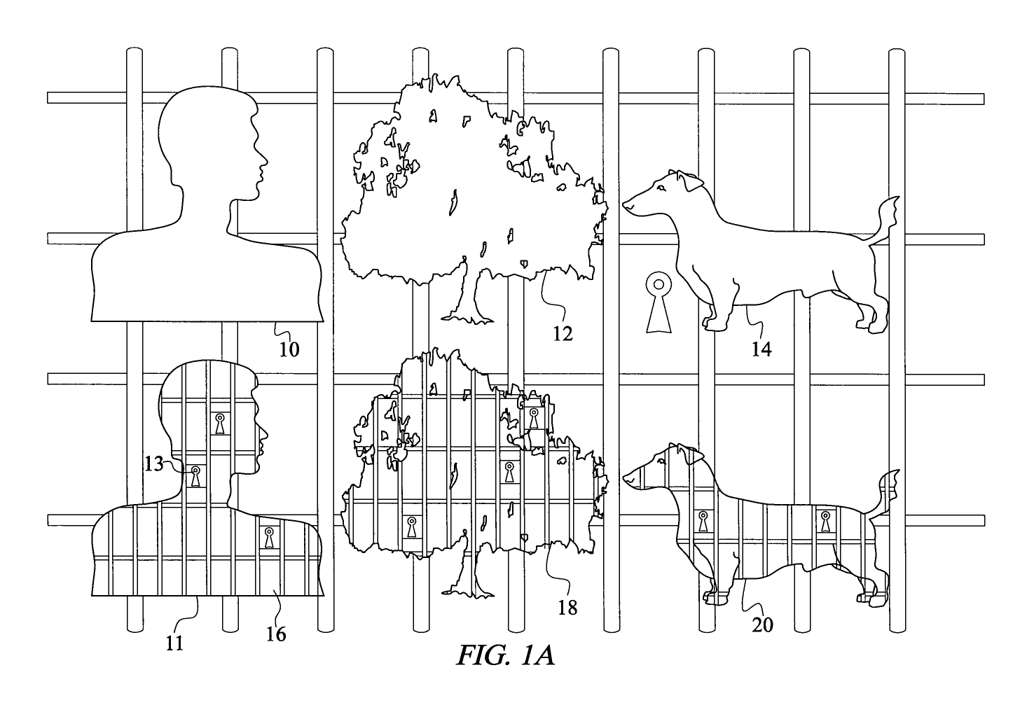

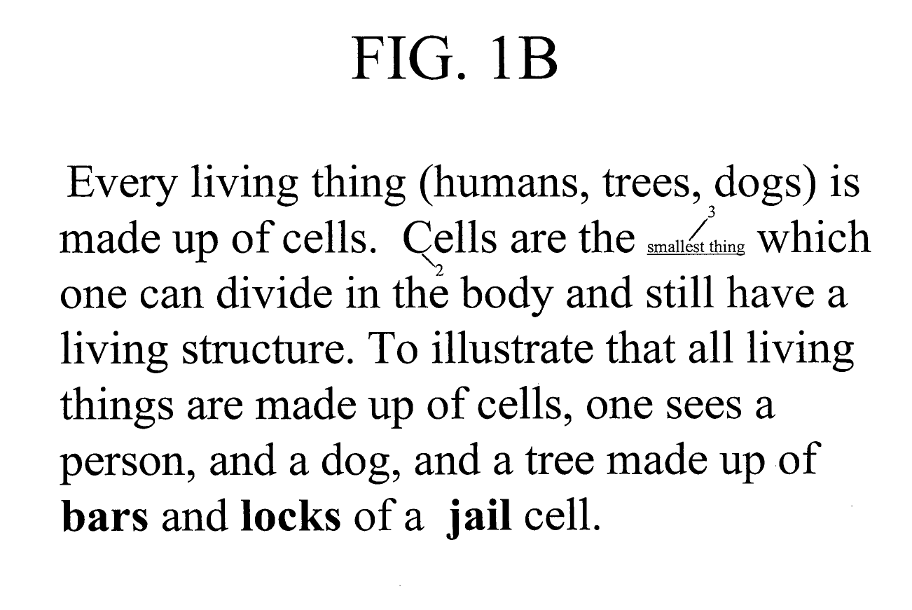

Information may be words or concepts. In FIG. 1A, the word “cell” in the context of living things is associated with images of a “jail cell.” Here, the image illustrates that a person 16, is composed of bars 11 and locks 13 of a jail cell and associates the image of a familiar word with a similar sounding word. Similarly, a tree 18, and dog 20 are composed of such bars and locks as well. A “jail cell,” is a known object that may be associated with a “cell,” the smallest division of a living organism. Additionally depicted are silhouettes of the person 10, tree 12 and dog 14 that do not show the bars and locks, making them easier to identify, as living organisms.

In addition to the cell being a word, it is also a concept. Thus, the concept of a cell is correlated with an object associated with a word, or a concept, “jail cell,” that is depicted as having and comprising divisions of all living organisms. In FIG. 1B, a narrative which is provided that helps to associate the images to functional aspects of the concepts related to cells of living things. Text, syllables, acronyms, and images of objects may include color, size, word sounds and the like. In FIG. 1A, the image is not animated but other objects may use animation to further reinforce associated functional aspects of concepts. In FIG. 1B, the narrative adjusts font size, shape and color. The change in size in font between “the smallest thing,” 2 and “cell,” 3, reinforces the association of the principle of the cell as the smallest living division of living things.

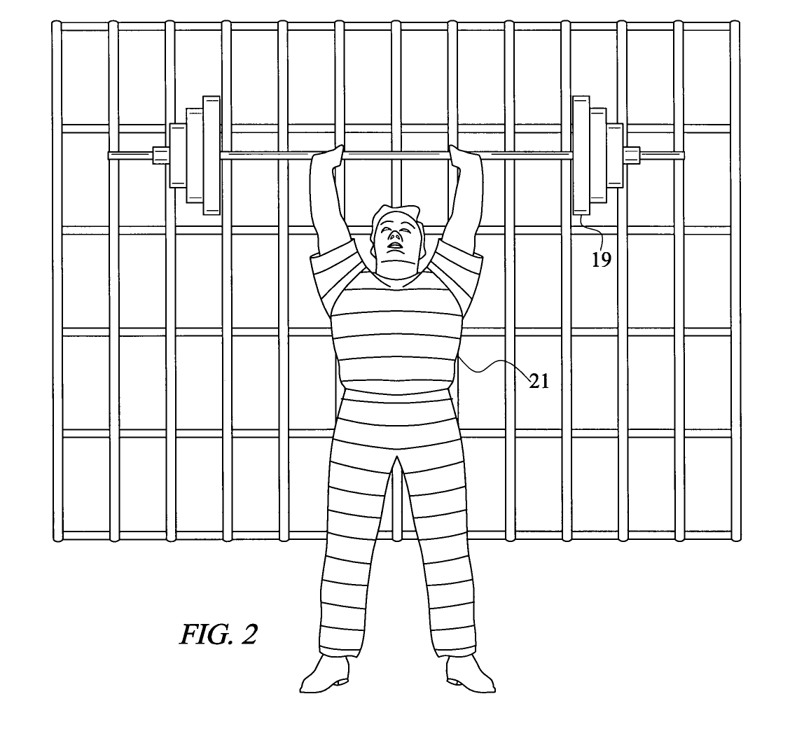

In another example as shown in FIG. 2, a mitochondrion, which serves as the energy or power source for a cell is associated with an image of a “mighty con” 21 (body builder in prison stripes) lifting weights 19 who is housed in a jail cell 17. A “mighty con” is associated with a cell's mitochondrion. This image builds on the association between a jail cell, referenced in FIGS. 1A-1B. The mitochondrion is located within the cell of living organisms and is the cell's powerhouse, providing energy for the cell. Thus, a physical attribute of one object, a “mighty con,” is correlated to the functional aspects of a mitochondrion, the powerhouse of a cell. The system of learning illustrated by FIGS. 1A-2 provides associations related to a cell and a mitochondrion that provide students with a knowledge of functional aspects of the mitochondrion and not merely a list of memorized keywords. Instead, the student is capable of remembering that the mitochondrion (mighty con) is the powerhouse of the cell (jail cell), which is the smallest living division of complex organisms.

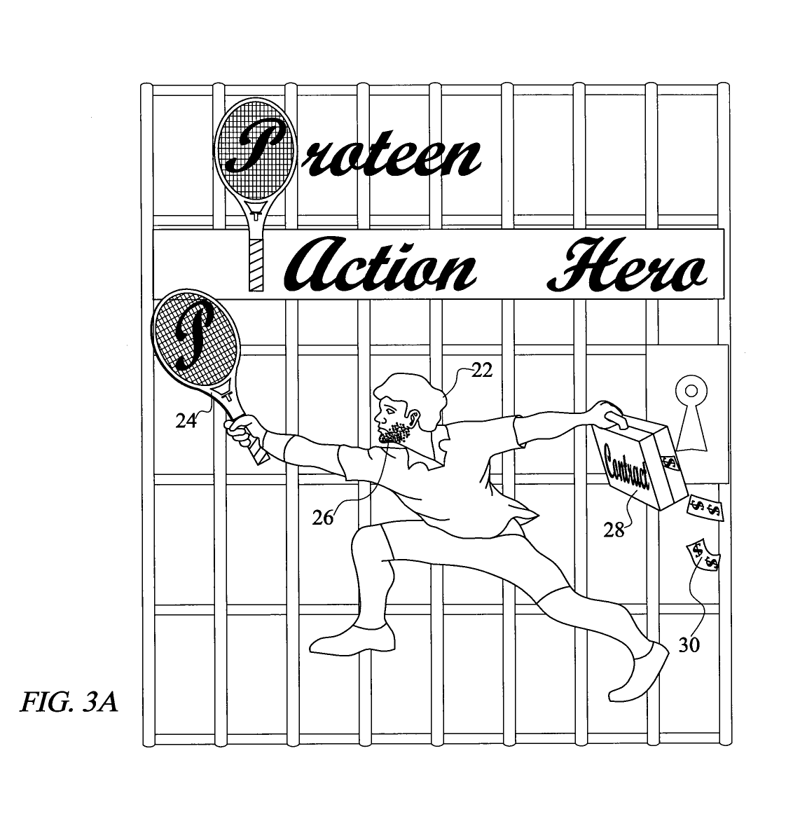

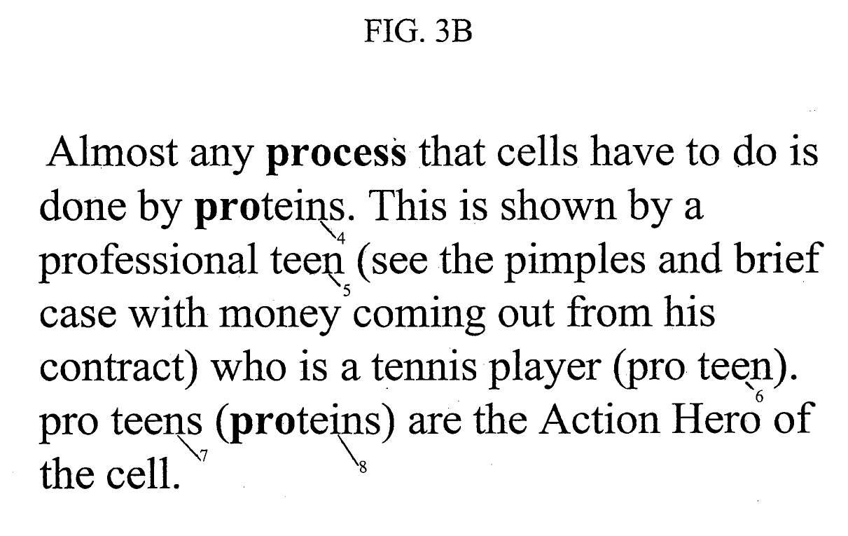

In FIG. 3A, the word, “protein” is associated with an image of a “pro teen,” a professional teenager, who happens to be a tennis player in this example. Proteins are used in many processes. The word protein is associated with a “pro teen” by depicting a teenager 22 having pimples 26, holding a tennis racket 24 and a briefcase 28 with money 30 coming out of the briefcase. Proteins may be described as action heroes of the cell. The two syllables of a word “protein” have a similar sound as the words “pro”(professional) and “teen”(teenager). The professional teenager is also an action hero on the tennis court. In FIGS. 3A-3B, the “pro teen” is associated with the cell, using the bars of the jail cell in the background. In another example, the net on the tennis court may be represented by bars of a jail cell. Colors, shading and font size are used to associate the words with images. The images of FIG. 3A may be animated to show action, for example.

Common features explained in keyword associations may be correlated and/or emphasized with various font sizes and/or colors. In FIG. 3B, the syllables “tein” of the word protein (i.e., red texts 4, 8) and “teen” of the word “pro teen” (i.e., red texts 5,6,7) are illustrated with red color to improve ease of association. (Color not depicted in the figure.) Teenagers often have red pimples. In order to further emphasize and correlate the features of a “teen,” i.e., red pimples, with the syllable “tein,” both syllables are shown in red.

In addition to keyword association and creative text application being utilized in examples of the invention, another associative learning technique, logic association is used. In one example of logic association, association is utilized in which one finds a characteristic object in which logical reasoning will show, has a commonality with an original word or concept. Thus, the object will represent the concept.

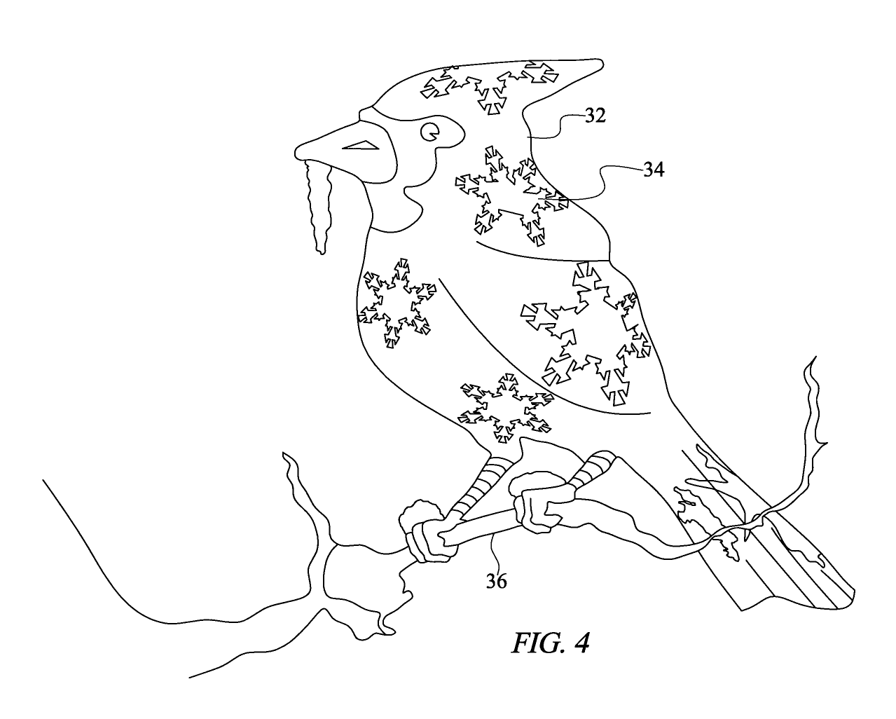

In FIG. 4, a red cardinal 32 with white snowflakes 34 is perched on a branch 36 of a tree with a blue sky 35 in the background. Psoriasis, a disease of the skin, creates red lesions on humans, which have a white flaky scale above the red affected areas, which look like sores. Psoriasis, is associated with a familiar object, a cardinal, because they have some commonality between them, e.g., redness. For example, the commonality is shown between “soars” (i.e., a flying bird) and “sores” (i.e., red swollen areas). A cardinal “soars” and a disease, psoriasis, causes “sores.” Images of an animated soaring cardinal (not shown) may be used to further associate the term, psoriasis with the “soaring” of a cardinal. The white snowflakes on the cardinal's wings helps to associate psoriasis with its white flaky scale on the red sores. Thus, an association is made between functional aspects of psoriasis and a red cardinal and snowflakes.

As with keyword word association, common features being explained in the logic associations may be correlated and/or emphasized with various fonts sizes and/or colors. For example, the cardinal 32 soars in the blue sky 35 (color not depicted). “Soar in the blue sky” may be added as text in the figure and may be depicted with a blue color. The sound of a concept, “sores” in the word, psoriasis, has commonality with a concept that a cardinal would be associated with, i.e., “soar in the blue sky.” To reinforce a logical connection, text may be used to provide a narrative explaining that the cardinal cannot soar in the blue sky because it has red sores with white flaky scale (snow) indicating psoriasis. After treating with a proper protocol, an animated cardinal could be shown soaring into the blue sky.

In FIG. 5, a black car 40 is shown with buns 38, 42 on the roof. In an example of keyword association, the word, “carbon” is associated with something else, “car bun.” In an example of logic association which associates the black car with sources of carbon that are black, the car is black. Major sources of carbon-based fossil fuels, such as coal and oil are black. Thus, a commonality exists between materials containing carbon and the car, i.e., the same black color. Even though carbon, itself, is not associated with a black color, the association works to teach a concept that black coal and oil are carbon-based fuels. This association may be reinforced using text, as previously described.

Keyword and logic association images and creative text applications may be utilized with one of the following technologies and/or interactive systems. In one example, the system utilizing these embodiments of the invention is an electronic visualization system. Examples of electronic visualization systems include computer monitors, televisions, personal digital assistants or other personal electronic devices such as a cell phone or a portable digital media player. (e.g., an iPod.®¹) Alternatively, in other examples, other electronic devices such as ¹iPod® is a registered trademark of Apple Computer, Inc. Sony Playstation® or Microsoft Xbox® are used.² For example, an electronic visualization system may display the embodiments depicted in FIGS. 1-4 either statically or as animations. Other systems utilizing the various embodiments of the invention may employ video games or three-dimensional physical objects such as puzzles, and toys. Toys include action figure-like objects or action figures. In a still another example, a system of learning concepts may utilize an interface comprising an audible output. Preferably, animation is used to reinforce associations between images and functional aspects of concepts, such as soaring birds and soars caused by a disease.²Playstation® is a registered trademark of Sony Computer Entertainment, Inc. and Xbox® is a registered trademark of Microsoft Corporation.

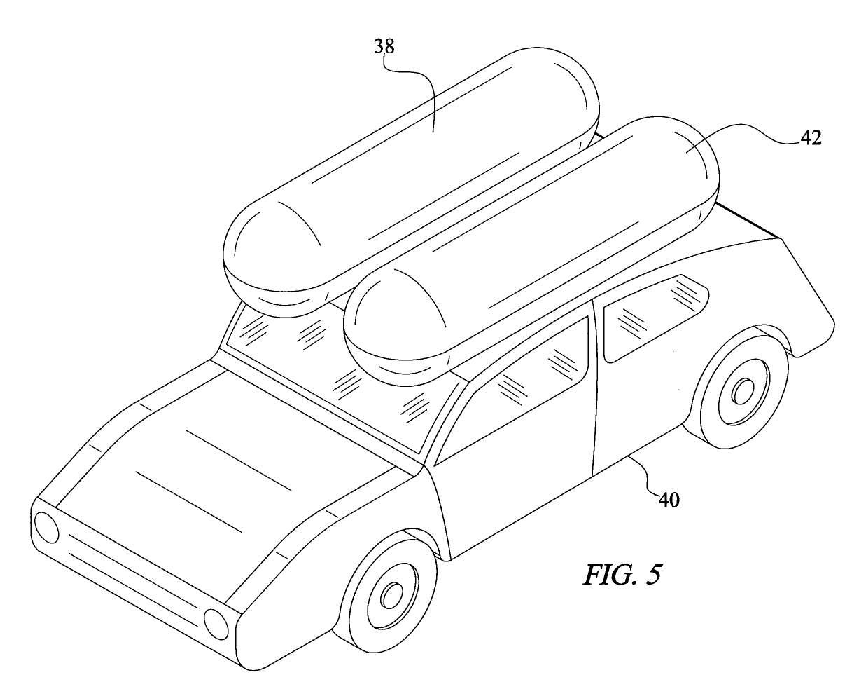

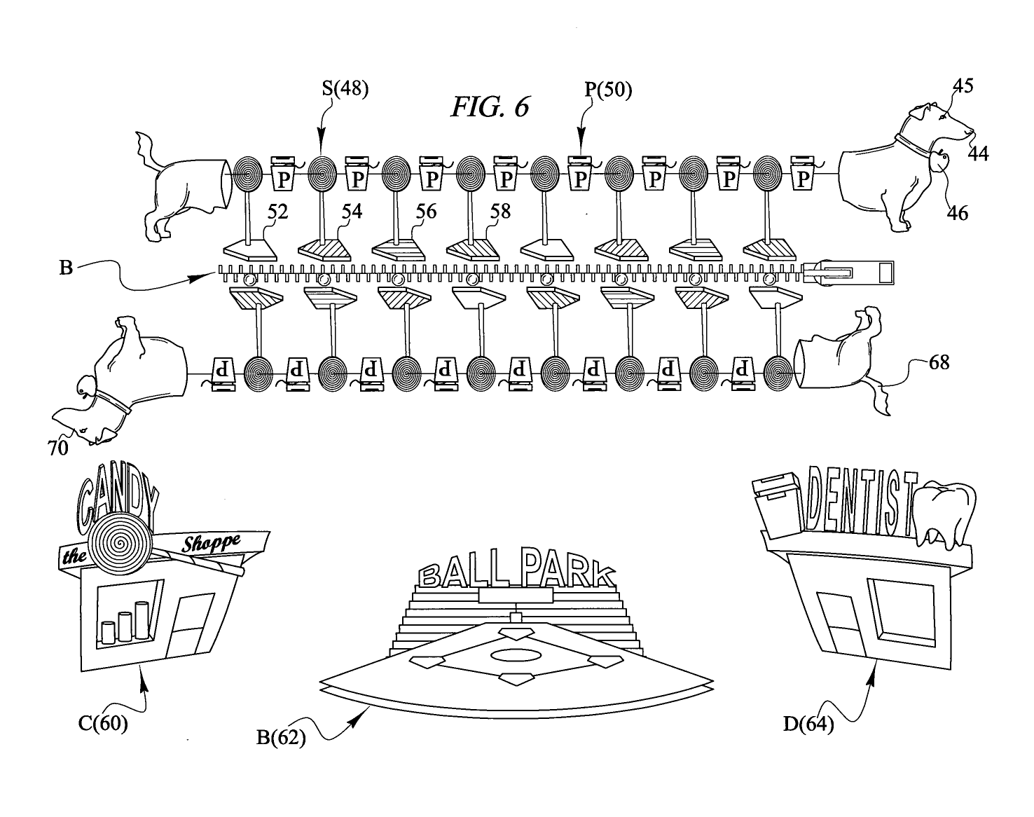

A video game system is represented in FIG. 6. The player is instructed to build a keyword associated image for the molecule DNA or deoxyribonucleic acid. In this example, DNA is associated with “Dog N Apple” or a dog 44 with an apple 46. The female dog is a female terrier 44 with a red eye 45 or “her red eye terrier” and an apple 46. The word, “her red eye terrier” is associated with “hereditary” material of life, DNA. DNA consists of a chain of nucleotides which consist of a sugar (S), a phosphate (P) and four kinds of bases, Adenine (A), Thymine (T), Cytosine (C), and Guanine (G). For example, through keyword association of “Dog N Apple” (DNA), the sugar phosphate backbone of DNA is illustrated as a backbone of DNA.

A lollipop 48 represents a sugar (S) as lollipops are sweet as sugar. The sugars may also be represented as candy canes in one example. The lollipop 48 is connected to one of four bases, which are illustrated as four different colored baseball bases, Adenine 54, Thymine 56, Cytosine 58 and Guanine 52. A ball park 62 from baseball is also depicted. In addition to a keyword association of DNA base with a baseball base 62, color is chosen in order to be associated with basis of the first letter of each base. For example, G stands for Guanine and hence is green. A stands for Adenine and is amber-colored. Thymine (T) is teal colored and Cytosine (C) is coral colored. With the previous examples involving the DNA bases, color is not shown in FIG. 6. In the video game, a player begins with an upside down dog 70 and the posterior end 66 of the right side up dog 44. In one example, a video character (not depicted) will build the right side up dog by going to a candy shop 60 to obtain the sugars, (i.e., lollipop 48), a baseball park 62 to obtain the correct bases, and a dental office 64 to obtain floss 50, which is used as an association with phosphate (i.e, floss-fate). Also depicted are a front end 70 and a posterior end 68 of a view of a dog shown upside down. The phosphate (P) in floss 50 represents the phosphate which forms the backbone of DNA and is shown as dental floss. In an example of keyword association, the sound of “floss” is associated with the sound of the syllable, “phos” of phosphate and the image of a container of floss helps the student to learn the concept that phosphate forms the backbone of the DNA (i.e., Dog N Apple).

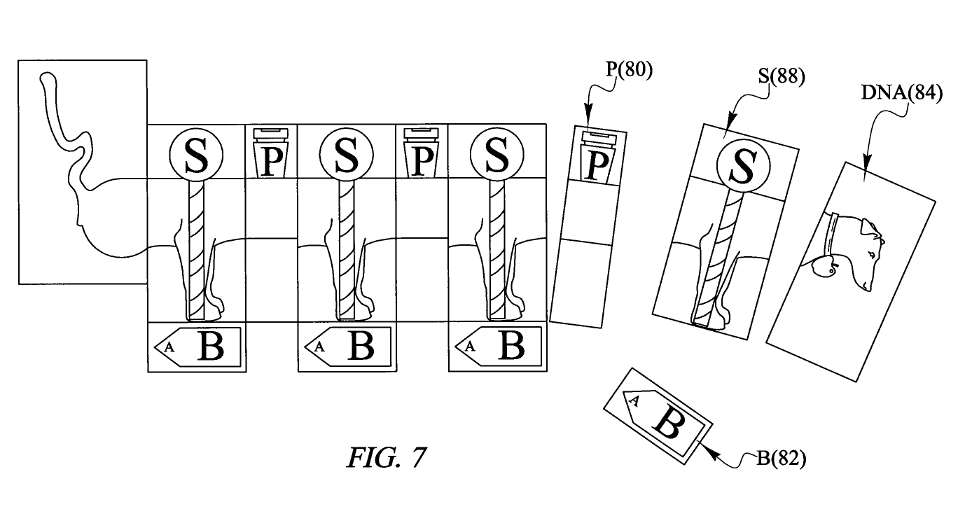

FIG. 7 depicts a puzzle with a phosphate 80 with a sugar 88, a Dog N Apple 84, i.e., “DNA” and a base 82. The student must assemble the pieces into a strand of DNA, reinforcing the association of the images, sounds and concepts.

Word association with a recognizable image is combined with a logical association relating to functional aspects of the concepts that are being taught. In this way, abstract concepts may be taught and relate to easily recognizable and memorable images that teach functional aspects of the concepts of what cells are and how they work in biology, as shown in FIGS. 1-7. The use of font size, color, and other attributes reinforces the association between the images, text and concepts being taught, improving retention of keywords and the functional aspects of concepts related to keywords. One example is capable of building on the next to reinforce retention of all of the keywords and concepts.

Sounds are incorporated in a system of learning to correlate an association between a sound and a concept. In one example, a process of cellular death, i.e., apoptosis, is associated with a “popping” sound. Other images, text, and colors, or other associations, may be associated with functional aspects of apoptosis. The sound may be included by a mechanical devices, an electrical element or as part of an electronic visualization system.

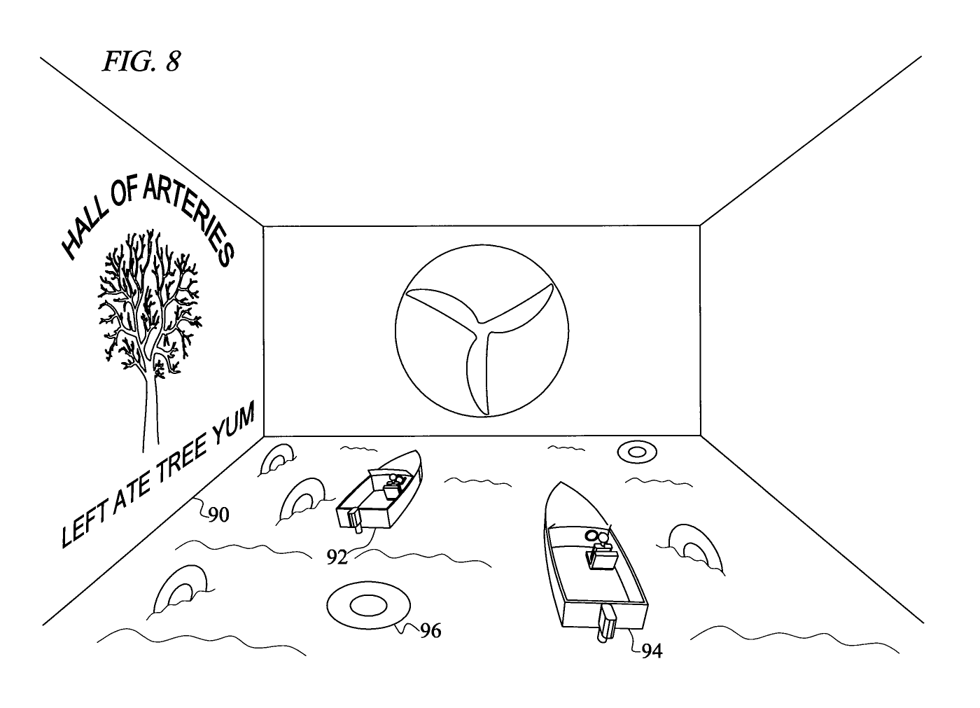

Concepts may also be explained through an imagery-based narrative. In one example, a racing narrative may be used to teach the functional associations of a biological process such as a physiological process. One such physiological process described in FIGS. 8-9 involves the circulatory pathway. In FIGS. 8 and 9, boats, a white boat 92 (color not depicted), and a red boat 94 (color not shown in the figure) respectively represent white blood cells and red blood cells, and a purple plate 96 (color not depicted) represents another cell, a platelet, which is illustrated as purple since it stains purple color using a routine staining method. It is to be noted that in FIGS. 8 and 9, boats 92, 94 and purple plate 96 are designated with the same numbers.

Blood which includes white blood cells, red blood cells and platelets, moves from “left at tree yum 90” (left atrium) in FIG. 8 to art galleries 100 (arteries) of FIG. 9. In one example, a boat race scenario may be incorporated into a video game. By repeated racing through blood vessels in a video game, students repeatedly reinforce functional aspects of the associations for concepts related to the circulatory system. In other examples, racing imagery may be used to reinforce functional aspects relating to processes involving bones, nerves, digestive tract, urinary system other pathways and geographical locations. Indeed, racing imagery may be used to associate any set of related concepts, such as the process of glycolysis, which proceeds along a known path or timeline.

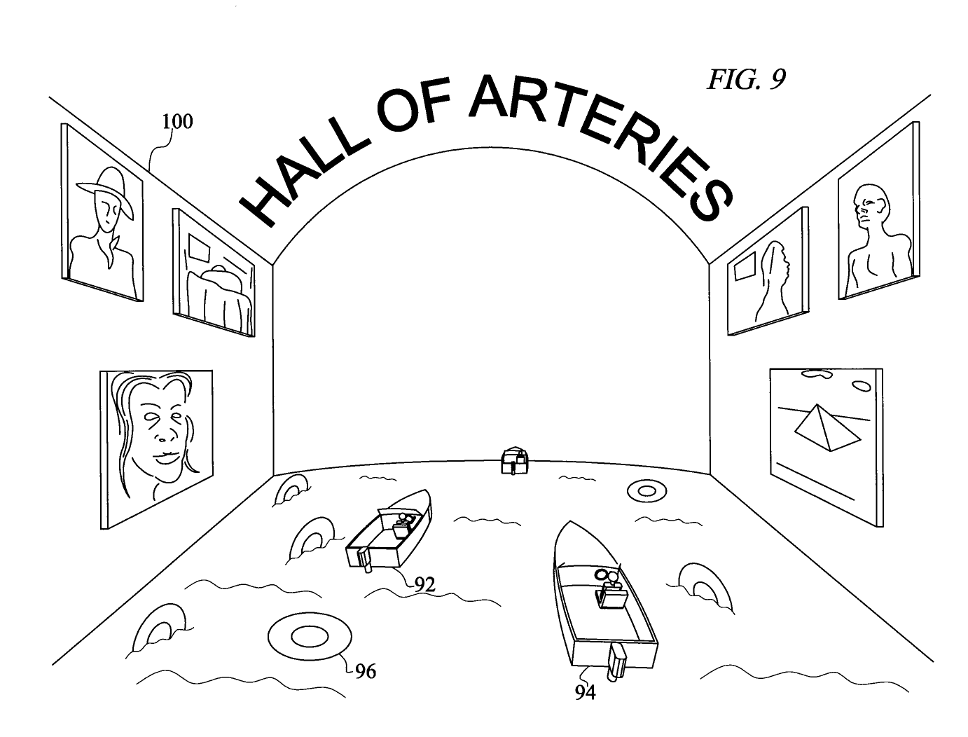

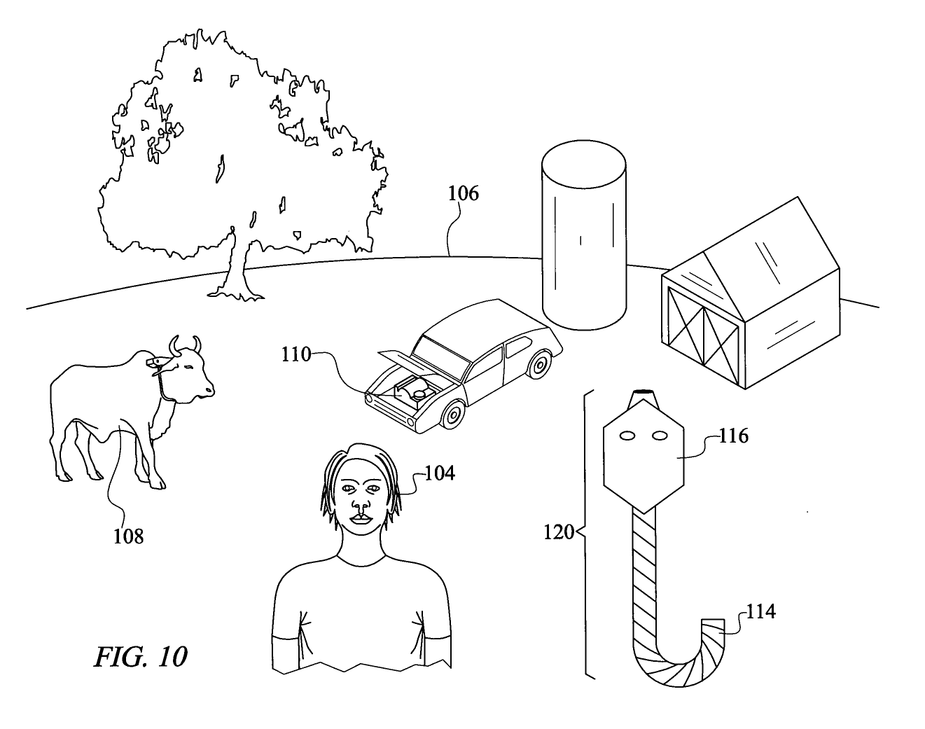

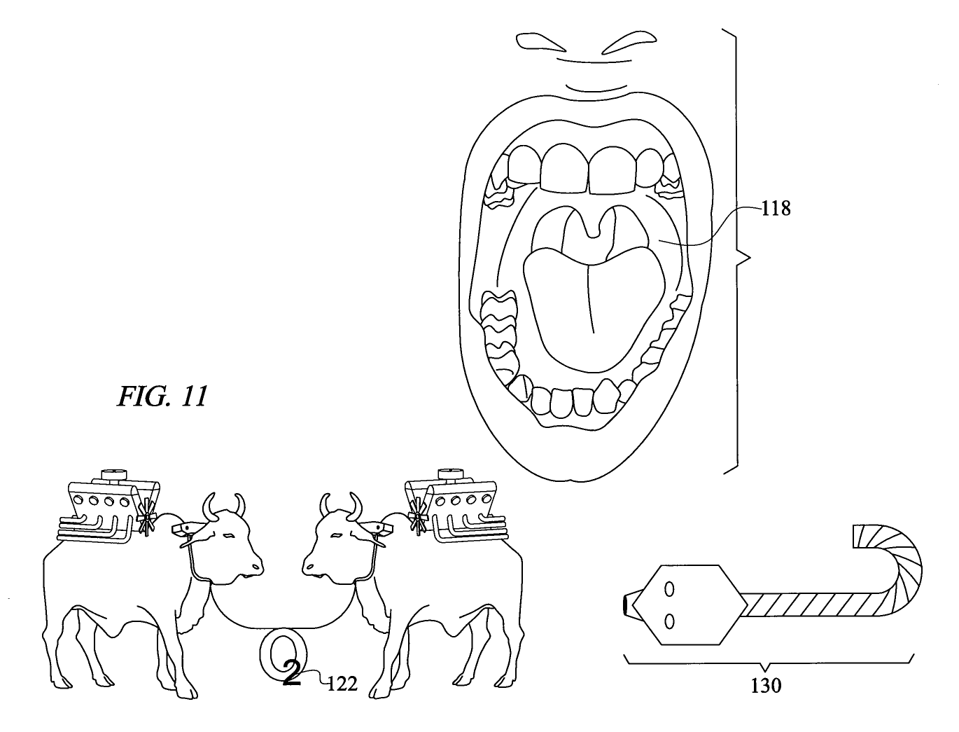

In another example of an imagery-based narrative, the process of energy generation in a cell (i.e., glycolysis and Krebs cycle) is illustrated by animated image teaching how oxygen and glucose enter the body, creating molecules for energy generation, (i.e., adenosine triphosphate or ATP) and by-products of carbon dioxide and water. In one example, oxygen and glucose travel to the muscle for energy generation. One imagery-based narrative is illustrated in FIGS. 10-18. Various molecules and cellular components are illustrated through symbolic representations. In FIG. 10, a female singer 104 sings an native American song. Her vocal cord muscles must generate ATP. This may be presented by text, narration or sequential images zooming in to show more detail about the vocal cords, and processes that energize the cells. In the pasture 106 of FIG. 10, there is an ox 108 and an engine 110, which are both associated with oxygen 122. In this example, the singer 104 needs energy by taking in glucose, or “glue ghost 120,” which is the sugar needed in energy processes. The glue ghost 120, consists of two components, a candy cane 114, which may be used to represent a sugar, and a glue bottle 116, which appears similar to a ghost. This glue ghost 120 is one example of a symbolic representation that is associated with glucose. In FIG. 11, the glue ghost 130, i.e., glucose, and an ox engine 122, i.e., oxygen, enters through the singer's mouth 118. These substances enter the stomach and into the blood (animation not shown).

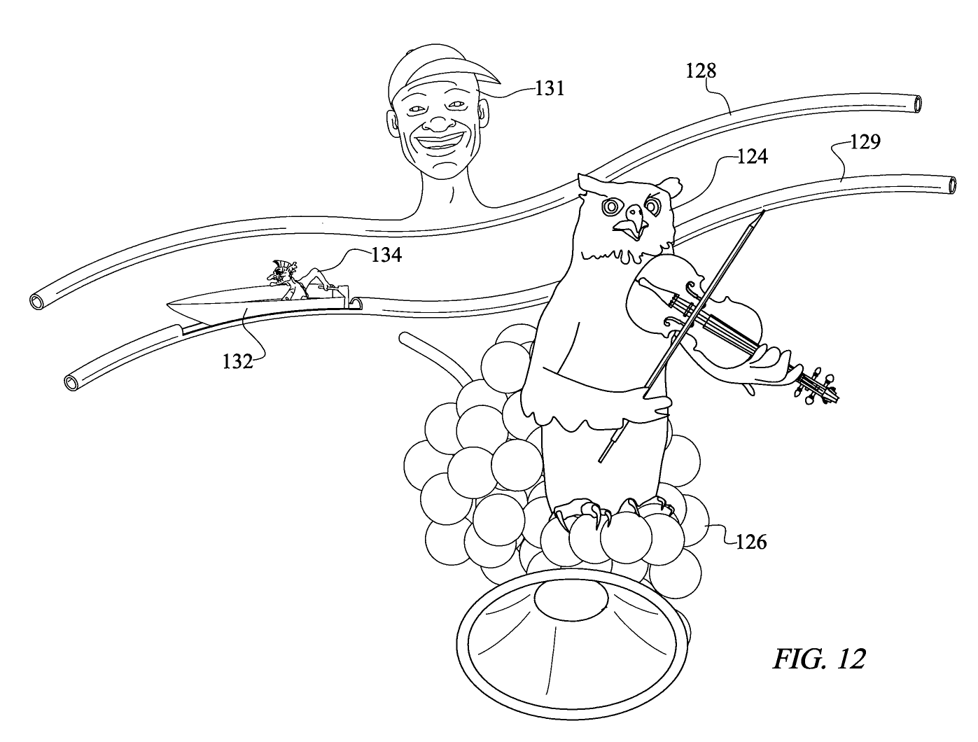

In FIG. 12, the alveoli of the lungs are depicted as an owl holding a viola or an owl viola 124 (alveola). The owl 124 is perched on a bunch of grapes 126 because the alveoli are often described as grape-like sacs which hold air. Next to the owl with a viola 124, are two capillaries 128, 129, with one of the capillaries, tube 128, including a person 131 with a cap who is laughing. The “cap hilarious” is associated with a capillary. In the other capillary 129, a red boat 132, (color not depicted) which represents a red blood cell, houses a male goblin 134 with a Mohawk haircut, “He-mo-goblin,” and is associated with hemoglobin, the oxygen-carrying component of red blood cells. These symbols may be repeated in other exercises to reinforce associations.

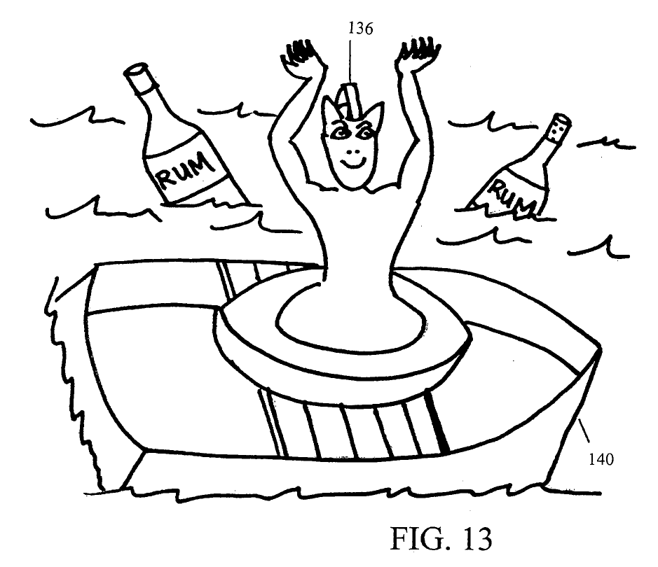

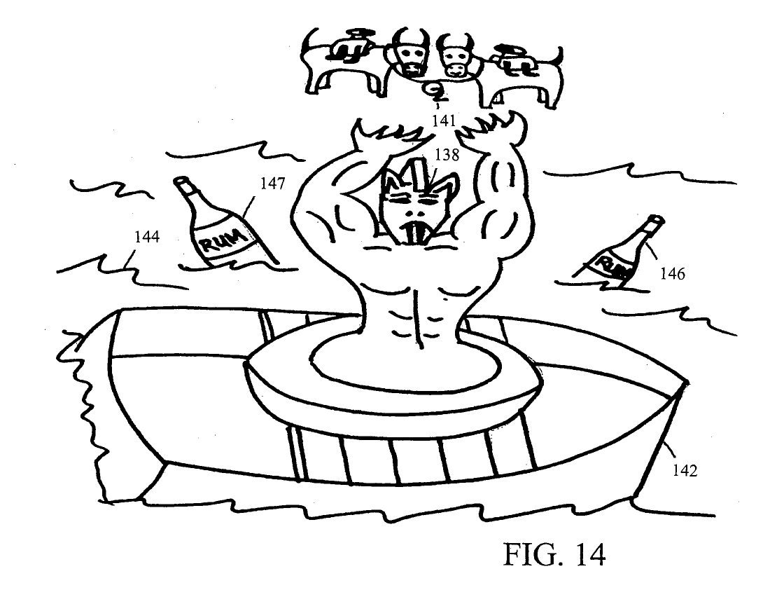

FIGS. 13 and 14 represent the deoxygenated and oxygenated states of hemoglobin. In FIG. 13, a he-mo-goblin 136 is shown as a thin goblin 136 housed in a blueish red boat 140 (not depicted with color in the figure). This he-mo-goblin 136, is associated with the deoxygenated state of hemoglobin. Hemoglobin is an oxygen carrier that is capable of carrying oxygen molecules. The boat 140 is depicted as blueish red, (not depicted in the figure.) in order to symbolize hemoglobin's deoxygenated state. In FIG. 14, a muscular he-mo-goblin 138 is shown as carrying an “ox engine” 141 associated with oxygen. The he-mo-goblin 138 is associated with the oxygenated state of hemoglobin. The boat 142 is now illustrated as blood red (not illustrated in the figure).

FIGS. 13-14 illustrate another biochemical process, allosteric regulation or more appropriately, allosteric activation. When hemoglobin binds the first molecule of oxygen, the first oxygen bound protein subunit induces a conformational change in the hemoglobin complex and allows for other hemoglobin protein subunits to have increased affinity for oxygen. Thus, the skinny he-mo-goblin 136 becomes a muscular he-mo-goblin 138. Additionally, the red boat 142 is in a yellow sea 144 (not illustrated as colored) with rum bottles 146, 147. This teaches the concept that sea rum (i.e., serum) is a yellow component of blood and it is the red blood cells, i.e., the red boat 142, that give blood its color. Again, the narrative may be taught by text, narration, and/or animation, for example.

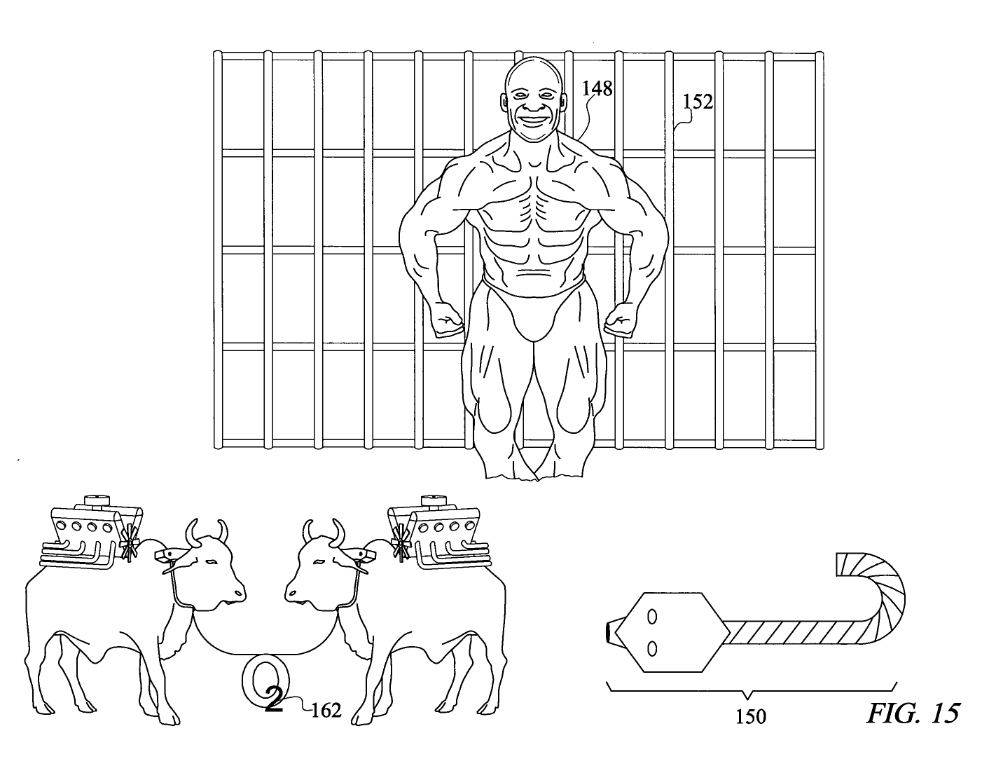

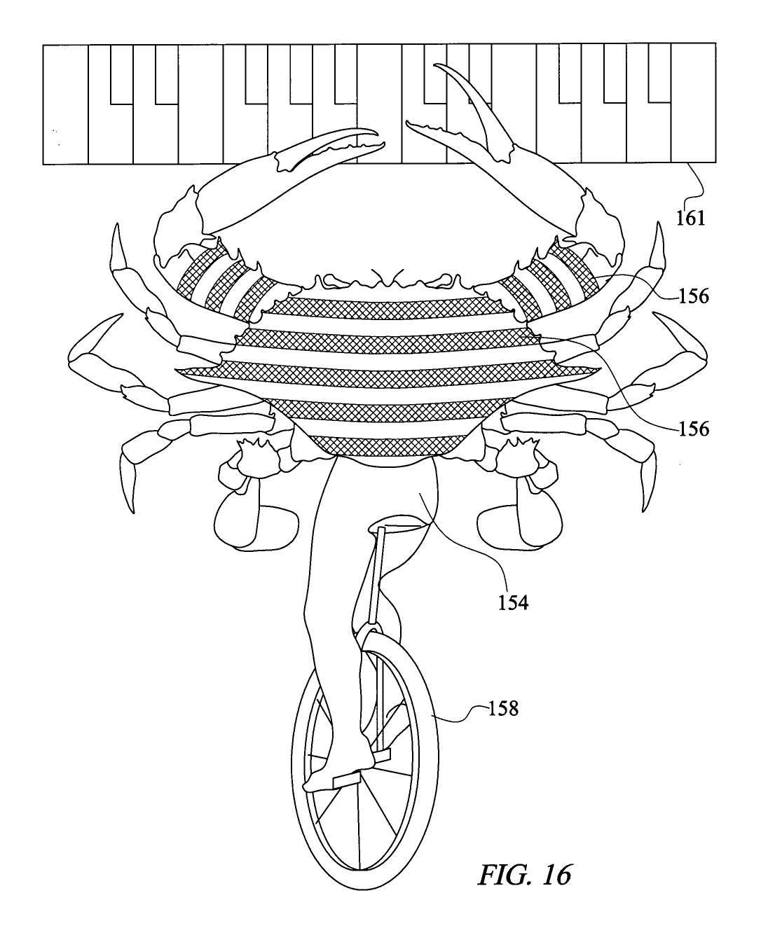

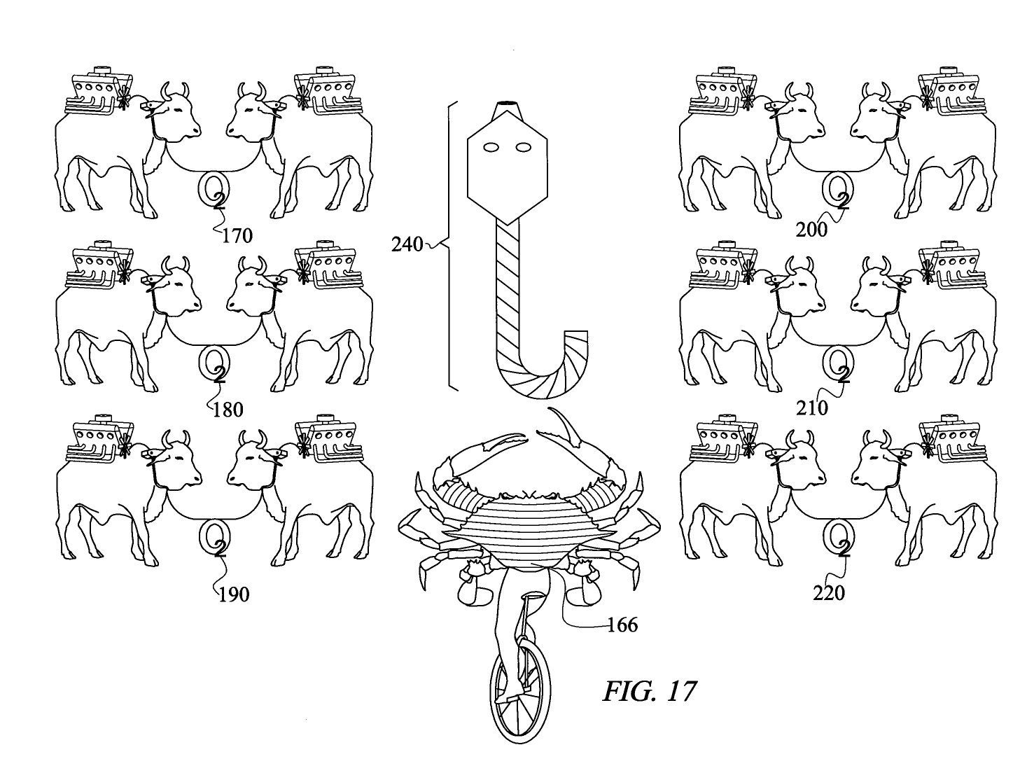

In FIG. 15, a muscle man 148 posing in front of a jail cell 152, represents a muscle cell. An ox engine 160, (oxygen) and a glue ghost 150 (glucose), are next to the muscle man 148, in order to illustrate that that they must enter the muscle cell. In the example of FIG. 16, the mitochondrion, which is an organelle that produces energy in a muscle cell, is represented by a crab 154 on a bicycle 158 with a convict's uniform 156. The crab 154 is playing on an organ 161. The mitochondria in cells make energy by a process called the Krebs cycle, which in one example, is equated with a crab on a cycle. In FIG. 17, a mitochondrion, is represented by a similar crab 166 and above this crab, are 6 ox engines (oxygens) 170, 180, 190, 200, 210, 220 and one glue ghost 240 (glucose). Six oxygens and one glucose are needed to make energy. In an alternative example, a “mighty con” may be associated with the mitochondria. In one example, the mighty con may be shown riding a unicycle with a crab hanging from his shoe. This alternative association may be used to represent the same functional aspects of the biochemical process used to energize the cells.

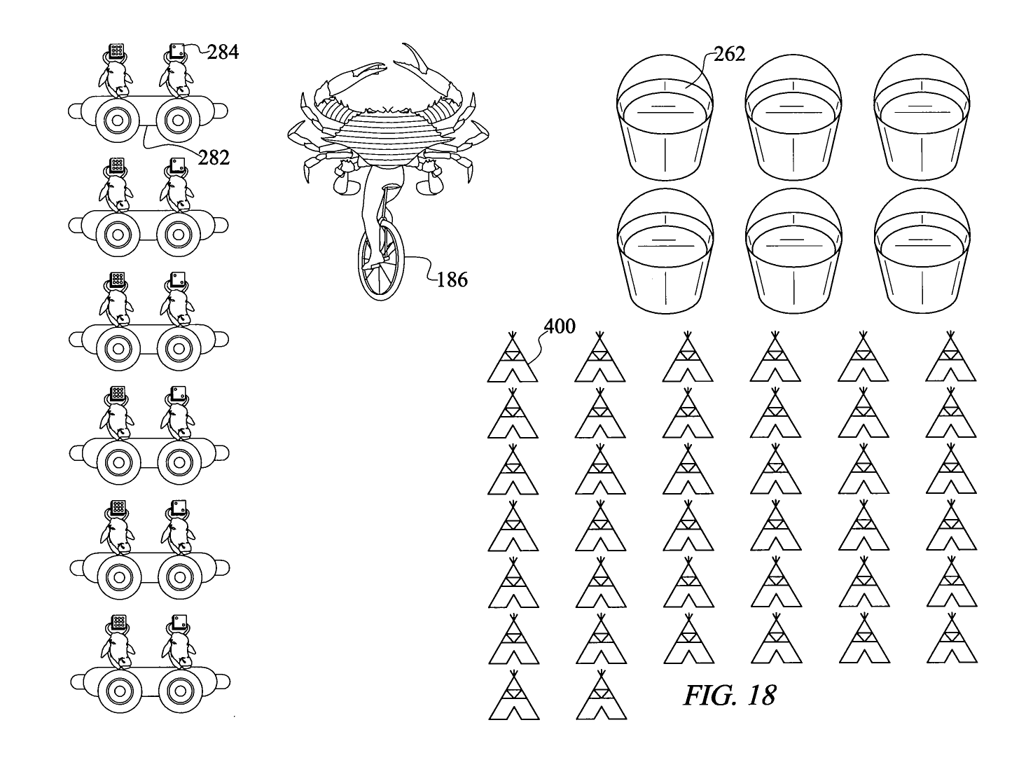

In FIG. 18, six carbon dioxide molecules, 6 water molecules, and 38 ATP are shown. Oxygen and glucose are consumed to generate carbon dioxide, represented by a “car-bun” and 2 “ox dies,” shown in 282 and 284, respectively, for example. The six waters are represented by water pails such as 262, for example. The 38 ATPs' (i.e., “A Tepees”) are represented by 38 tepees, such as a tepee 400, for example. Thus, the female singer 104 in the pasture 106 can now sing a Native American song because she now has plenty of ATP. FIGS. 10-18 may be animated, as one example of an imagery-based narrative. An animation based on FIGS. 10-18 may build on cartoon associations for mitochondria, cells, formation of ATP from glucose and oxygen, providing an imagery-based narrative for associating the Krebs cycle to the images associated with functional aspects of cell biochemistry.

Alternative combinations and variations of the examples provided will be apparent based on this disclosure. It is not possible to provide specific examples for all of the many possible examples used to associatively learn functional aspects of concepts. In the examples, the system was used to learn all biochemistry; however, other keywords and other functional aspects may be taught in other educational fields. The use of associative learning systems is not limited to cell biochemistry.

What is claimed is:

1. A system of learning a concept comprises: a visually perceptible image associated with a concept such that a logical association is established between the image and a functional aspect of the concept.

2. The system of learning of claim 1, wherein the image is animated, and the system further comprises associating movement of the image with a functional aspect of the concept.

3. The system of learning of claim 1, further comprising rendering the image as a cartoon and providing text describing the association between the cartoon and the functional aspects of the concept.

4. The system of learning of claim 1, further comprising naming the image such that the name of the image sounds similar to words describing the functional aspect of the concept.

5. The system of learning of claim 3, further comprising using font size or color to reinforce the association between the text, the image, and the functional aspect of the concept.

6. The system of learning of claim 5, wherein the step of using includes using a text color that is the same as the color of an image associated with a keyword represented in the text.

7. The system of learning of claim 1, further comprising associating a shape of the image to a functional aspect of the concept.

8. The system of claim 1, further comprising providing an interactive user interface.

9. The system of claim 8, wherein the interactive user interface is an electronic visualization system.

10. The system of claim 9, further comprising displaying the electronic visualization system as a cell phone or portable electronic device.

11. The system of claim 10, wherein the portable electronic device is a portable digital media player.

12. The system of claim 10, wherein the portable electronic device is a cell phone.

13. The system of claim 8, wherein the interactive user interface is a video game.

14. The system of claim 1, wherein the step of associating associates a functional aspect of the concept with a physical object.

15. The system of claim 14, wherein the physical object is a puzzle.

16. The system of claim 14, wherein the physical object is a toy.

17. The system of claim 16, wherein the toy is an action figure.

18. The system of claim 1, wherein the step of associating associates a sound with a keyword or a portion of a keyword; and generating an audible sound such that the sound and the keyword are associated with a functional aspect of the concept.

19. The system of claim 1, further comprising providing an imagery-based narrative such that association between the image and functional aspect of the concept are reinforced.

20. The system of claim 19, wherein the imagery-based narrative includes combining the image with text, narration or animation.

21. The system of claim 20, wherein the image is combined with text, and the text uses color or font size to reinforce associations between keywords and a functional aspect of the concept.

22. The system of claim 1, wherein the Krebs cycle is the functional aspect of the concept and the image includes a feature associated with a mitochondrion.

23. The system of claim 22, wherein the image includes a mighty con as the feature of the image.

24. The system of claim 1, wherein the image is one of a plurality of images and the plurality of images are used in a step of imagery-based narrating.

25. The system of claim 24, wherein the step of imagery-based narrating includes associating narrative text and the image with functional aspects of a concept.

26. The system of claim 25, wherein the concept is a process.

27. The system of claim 25, wherein the step of imagery-based narrating includes progressing along a time line or path.

28. The system of claim 25, wherein the step of imagery-based narrating includes an interactive video game.
